(19) United States
(12) Patent Application Publication
(10) Pub. No.: US 2026/0130364 A1
(43) Pub. Date: May 14, 2026

(54) CAPSULE FOR CONTROLLED RELEASE PESTICIDE AND CONTROLLED RELEASE PESTICIDE COMPRISING THE SAME

(71) Applicant: LG CHEM, LTD., Seoul (KR)

(72) Inventor: Ki Hyun RYOO, Daejeon (KR)

(73) Assignee: LG CHEM, LTD., Seoul (KR)

(21) Appl. No.: 19/119,155

(22) PCT Filed: Oct. 24, 2023
(86) PCT No.: PCT/KR2023/016585

§ 371 Date: Apr. 8, 2025

(30) Foreign Application Priority Data
Oct. 24, 2022 (KR) 10-2022-0137389

(51) Int. Cl. A01N 25/28; A01N 53/00; A01P 7/04

(52) U.S. Cl. CPC A01N 25/28; A01N 53/00; A01P 7/04

(57) ABSTRACT

The present invention relates to a capsule for a controlled release pesticide and a controlled release pesticide including the same. Specifically, the present invention has advantages in that, when lambda-cyhalothrin is included as a pesticide in a capsule, which is prepared from a composition including Polymeric Methylenediphenyl diisocyanate (PMDI) and toluene diisocyanate (TDI) in a certain ratio, in order to solve the problem of a lowered insecticidal effect due to drug decomposition, toxicity may be reduced compared to an EW formulation using an organic solvent, and the release characteristics of a pesticide drug may be controlled, which results in excellent sustainability of the insecticidal effect.

### CROSS-REFERENCE TO RELATED APPLICATIONS

This application claims priority to and the benefit of Korean Patent Application No. 10-2022-0137389, filed Oct. 24, 2022, the disclosure of which is incorporated herein by reference in its entirety.

### TECHNICAL FIELD

The present invention relates to a capsule for a controlled release pesticide to solve the problem of a lowered insecticidal effect due to drug decomposition, a controlled release pesticide including the same, and a composition for preparing a controlled release pesticide.

### BACKGROUND ART

Cyhalothrin is an organic compound used as a pesticide, and includes isomers of gamma-cyhalothrin and lambda-cyhalothrin. Gamma-cyhalothrin is a pyrethroid compound and a synthetic pesticide that mimics the structure and characteristics of pyrethrin, which is a naturally occurring pesticide present in chrysanthemum flowers. Pyrethroids such as cyhalothrin are widely used as active ingredients in agricultural pesticides because they are cost-effective, and the drug effect lasts for a long time compared to natural pyrethrins. Gamma-cyhalothrin is used to control pests in a variety of crops, including cotton, grains, potatoes, and vegetables.

Most of the commercially available lambda cyhalothrin is an emulsion-in-water (EW) formulation. The EW formulation is prepared by dissolving a pesticide raw material in a small amount of a solvent that is insoluble in water, preparing the resulting mixture into an emulsion using an emulsifier so that the emulsion can be dispersed in small grains that are insoluble in water, mixing the emulsion with water, and then spraying the mixed emulsion. Existing EW formulations have an advantage in that they are very simple to prepare, but requires great attention in a production process because an organic solvent is necessarily used to prepare the EW formulation. Also, the EW formulation has a problem in that lambda-cyhalothrin, which is the active ingredient, comes into direct contact with the outside when a field is treated with a pesticide drug, so it is easily decomposed, which results in the insecticidal effect lasting for a short time. Accordingly, the cost burden increases because the field must be more frequently treated with the pesticide drug, and environmental pollution problems also arise due to frequent treatment of the pesticide.

Accordingly, there is a need to develop a novel pesticide formulation that has reduced toxicity compared to EW formulations using organic solvents, exhibits a rapid insecticidal effect due to excellent diffusivity, and has excellent sustainability of the insecticidal effect.

### Disclosure

### Technical Problem

Therefore, it is an object of the present invention to provide a microcapsule for a controlled release pesticide.

It is another object of the present invention to provide a controlled release pesticide having excellent sustainability of the insecticidal effect because the release characteristics of a pesticide drug are controlled.

It is still another object of the present invention to provide a composition for preparing a controlled release pesticide, which has excellent sustainability of the insecticidal effect because the release characteristics of a pesticide drug are controlled.

### Technical Solution

To achieve the above object,

According to one aspect of the present invention, there is provided a microcapsule for a controlled release pesticide, wherein the microcapsule is prepared from Polymeric Methylenediphenyl diisocyanate (PMDI) and toluene diisocyanate (TDI).

According to another aspect of the present invention, there is provided a controlled release pesticide including the microcapsule; and an insecticidal agent included in a space surrounded by the microcapsule.

According to still another aspect of the present invention, there is provided a composition for preparing a controlled release pesticide, which includes an insecticidal agent; a solvent; Polymeric Methylenediphenyl diisocyanate (PMDI) and toluene diisocyanate (TDI) serving as capsule-forming materials; a cross-linking agent; and a dispersant.

### Advantageous Effects

The present invention relates to a capsule for a controlled release pesticide and a controlled release pesticide including the same. Specifically, the present invention has advantages in that, when lambda-cyhalothrin is included as a pesticide in a capsule, which is prepared from a composition including Polymeric Methylenediphenyl diisocyanate (PMDI) and toluene diisocyanate (TDI) in a certain ratio, in order to solve the problem of a lowered insecticidal effect due to pesticide drug decomposition, toxicity can be reduced compared to an EW formulation using an organic solvent, and the release characteristics of a pesticide drug can be controlled, which results in excellent sustainability of the insecticidal effect.

### BRIEF DESCRIPTION OF DRAWINGS

FIG. 1 is a diagram confirming the diffusibility of lambda-cyhalothrin (Demand CS) of a conventional capsule suspension (CS) formulation and the diffusibility of lambda-cyhalothrin from the inside to the outside of capsules of pesticide formulations (R-025 and R-026) of Comparative Example 1 in which Polymeric Methylenediphenyl diisocyanate (PMDI) is used alone as the capsule-forming material and pesticide formulations (dispersant 1 (Cas No. 36290-04-7) and dispersant 2 (Cas No. 68425-94-5)) in which a combination of Polymeric Methylenediphenyl diisocyanate (PMDI) and 2,4-toluene diisocyanate is used as the capsule-forming material.

FIG. 2 is an image of a controlled release pesticide, which includes an insecticidal agent in an inner space surrounded by a microcapsule of the present invention observed under a microscope.

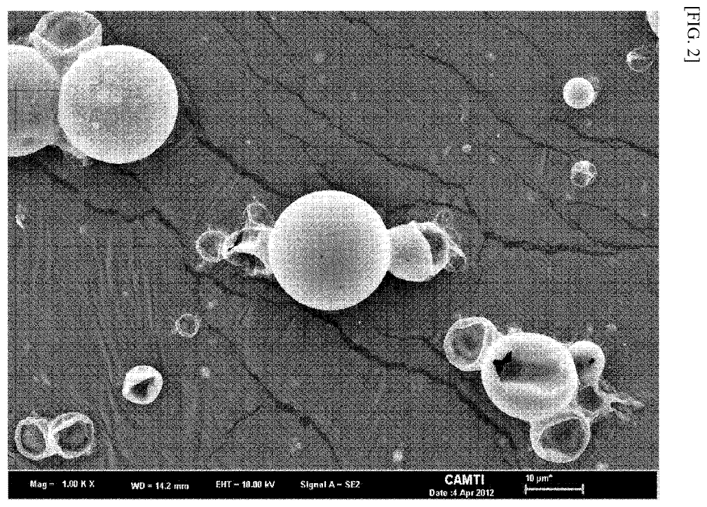

### MODES OF THE INVENTION

Hereinafter, the present invention will be described in detail.

### 1. Microcapsule for Controlled Release Pesticide

One aspect of the present invention provides a microcapsule for a controlled release pesticide.

The microcapsule is prepared from a high-molecular-weight polymer such as Polymeric Methylenediphenyl diisocyanate (PMDI) and a monomer such as toluene diisocyanate (TDI).

The Polymeric Methylenediphenyl diisocyanate (PMDI) is a material that forms the microcapsule and is a polymer of methylene diphenyl diisocyanate (MDI). Methylene diphenyl diisocyanate is an aromatic diisocyanate chemical, and 4,4′-MDI has two isocyanate groups positioned in parallel, and 2,4′-MDI and 2,2′-MDI exhibit different reactivity because the positions of isocyanate groups are different. In particular, 4,4′-MDI exhibit a reactivity that is approximately 4 times higher than 2,4′-MDI. According to one embodiment of the present invention, the Polymeric Methylenediphenyl diisocyanate of the present invention may be a polymer of 2,4-methylene diphenyl diisocyanate.

The toluene diisocyanate (TDI) is a material that forms the microcapsule, is a colorless liquid with a pungent smell at room temperature, and is dissolved in an organic solvent such as acetone, benzene, carbon tetrachloride, chlorobenzene, kerosene, nitrobenzene, and the like. TDI is a chemically synthesized product and includes a mixture of 2,4-TDI and 2,6-TDI isomers. According to one embodiment of the present invention, the toluene diisocyanate may be 2,4-toluene diisocyanate.

The microcapsule may be prepared from a composition including 0.1% by weight to 0.5% by weight, preferably 0.1% by weight to 0.2% by weight, and more preferably 0.12% by weight to 0.18% by weight of the Polymeric Methylenediphenyl diisocyanate.

The microcapsule may be prepared from a composition including 0.3% by weight to 1.5% by weight, preferably 0.3% by weight to 0.7% by weight, and more preferably 0.5% by weight to 0.6% by weight of the toluene diisocyanate.

In addition to the Polymeric Methylenediphenyl diisocyanate and the toluene diisocyanate, the composition may further include any one or more selected from the group consisting of a solvent, an emulsifier, a cross-linking agent, a dispersant, an anti-freezing agent, a thickener, a preservative, and an anti-foaming agent.

Any cross-linking agent may also be used as the cross-linking agent as long as it can cross-link the Polymeric Methylenediphenyl diisocyanate and the toluene diisocyanate, which are the capsule-forming materials, and may be preferably polyoxypropylenediamine or polyoxypropylenetriamine, and more preferably polyoxypropylenediamine.

The polyoxypropylenediamine may have an average molecular weight of 100 g/mol to 500 g/mol, preferably an average molecular weight of 200 g/mol to 500 g/mol, and more preferably an average molecular weight of 200 g/mol to 300 g/mol.

The polyoxypropylenediamine may have an average degree of polymerization of 1 to 7, preferably an average degree of polymerization of 2 to 7, and more preferably an average degree of polymerization of 2 to 3.

The microcapsule may have a particle size of 1 μm to 20 μm, preferably a particle size of 7 μm to 15 μm, and more preferably a particle size of 10 μm to 13 μm.

In one specific embodiment of the present invention, it was confirmed that a pesticide formulation in which a combination of Polymeric Methylenediphenyl diisocyanate (PMDI) and 2,4-toluene diisocyanate is used as the capsule-forming material has superior diffusibility from the inside to outside of a capsule compared to pesticide formulations in which lambda-cyhalothrin of an existing EW formulation and Polymeric Methylenediphenyl diisocyanate (PMDI) are used alone as the capsule-forming material, which results in an insecticidal effect that appears rapidly and lasts for a long time.

Therefore, the microcapsule for a controlled release pesticide according to the present invention may be used effectively used in a novel pesticide formulation because it exhibits a rapid insecticidal effect due to the excellent diffusibility of the insecticidal agent included therein, and also has excellent sustainability of the insecticidal effect.

### 2. Controlled Release Pesticide

One aspect of the present invention provides a controlled release pesticide.

The controlled release pesticide includes a microcapsule prepared from a high-molecular-weight polymer such as Polymeric Methylenediphenyl diisocyanate (PMDI) and a monomer such as toluene diisocyanate (TDI); and an insecticidal agent included in a space surrounded by the microcapsule.

The insecticidal agent is lambda-cyhalothrin.

The microcapsule is prepared from a composition including 0.1% by weight to 0.5% by weight, preferably 0.1% by weight to 0.2% by weight, and more preferably 0.12% by weight to 0.18% by weight of the Polymeric Methylenediphenyl diisocyanate.

The microcapsule is prepared from a composition including 0.3% by weight to 1.5% by weight, preferably 0.3% by weight to 0.7% by weight, and more preferably 0.5% by weight to 0.6% by weight of the toluene diisocyanate.

In addition to the Polymeric Methylenediphenyl diisocyanate and the toluene diisocyanate, the composition may further include any one or more selected from the group consisting of a solvent, an emulsifier, a cross-linking agent, a dispersant, an anti-freezing agent, a thickener, a preservative, and an anti-foaming agent.

Any cross-linking agent may also be used as the cross-linking agent as long as it can cross-link the Polymeric Methylenediphenyl diisocyanate and the toluene diisocyanate, which are the capsule-forming materials, and may be preferably polyoxypropylenediamine or polyoxypropylenetriamine, and more preferably polyoxypropylenediamine.

The polyoxypropylenediamine may have an average molecular weight of 100 g/mol to 500 g/mol, preferably an average molecular weight of 200 g/mol to 500 g/mol, and more preferably an average molecular weight of 200 g/mol to 300 g/mol.

The polyoxypropylenediamine may have an average degree of polymerization of 1 to 7, preferably an average degree of polymerization of 2 to 7, and more preferably an average degree of polymerization of 2 to 3.

The microcapsule may have a particle size of 1 μm to 20 μm, preferably a particle size of 7 μm to 15 μm, and more preferably a particle size of 10 μm to 13 μm.

The controlled release pesticide may be prepared using a method which includes: preparing an oil phase by dissolving an insecticidal agent and capsule-forming materials (e.g., Polymeric Methylenediphenyl diisocyanate and toluene diisocyanate) in an organic solvent, preparing a water phase in which an emulsifier is dissolved in water, and mixing the oil phase and the water phase, followed by addition of a cross-linking agent.

A dispersant, a thickener, an anti-freezing agent, an anti-foaming agent, and a preservative may be further added when the controlled release pesticide is prepared.

In one specific embodiment of the present invention, it was confirmed that a pesticide formulation in which a combination of Polymeric Methylenediphenyl diisocyanate (PMDI) and 2,4-toluene diisocyanate is used as the capsule-forming material has superior diffusibility from the inside to outside of a capsule compared to pesticide formulations in which lambda-cyhalothrin of an existing EW formulation and Polymeric Methylenediphenyl diisocyanate (PMDI) are used alone as the capsule-forming material, which results in an insecticidal effect that appears rapidly and lasts for a long time. Also, it was confirmed that a controlled release pesticide including Polymeric Methylenediphenyl diisocyanate and toluene diisocyanate in a certain ratio exhibits the fastest and best insecticidal effect.

Therefore, the controlled release pesticide of the present invention may be used effectively used as a novel pesticide formulation because it exhibits a rapid insecticidal effect due to the excellent diffusibility of the insecticidal agent included therein, and also has excellent sustainability of the insecticidal effect.

### 3. Composition for Preparing Controlled Release Pesticide

One aspect of the present invention provides a composition for preparing a controlled release pesticide.

The composition for preparing a controlled release pesticide includes an insecticidal agent, a solvent, Polymeric Methylenediphenyl diisocyanate (PMDI) which is a high-molecular-weight polymer and toluene diisocyanate (TDI) which is a monomer serving as capsule-forming materials), a cross-linking agent, and a dispersant.

The insecticidal agent is lambda-cyhalothrin.

The composition includes 0.1% by weight to 0.5% by weight, preferably 0.1% by weight to 0.2% by weight, and more preferably 0.12% by weight to 0.18% by weight of the Polymeric Methylenediphenyl diisocyanate.

The composition includes 0.3% by weight to 1.5% by weight, preferably 0.3% by weight to 0.7% by weight, and more preferably 0.5% by weight to 0.6% by weight of the toluene diisocyanate.

In addition to the Polymeric Methylenediphenyl diisocyanate and the toluene diisocyanate, the composition may further include any one or more selected from the group consisting of a solvent, an emulsifier, a cross-linking agent, a dispersant, an anti-freezing agent, a thickener, a preservative, and an anti-foaming agent.

Any solvent may be used as the solvent as long as the lambda-cyhalothrin, which is an insecticidal agent and the Polymeric Methylenediphenyl diisocyanate and toluene diisocyanate, which are capsule-forming materials are dissolved in the solvent. In this case, the solvent may be preferably any one or more selected from the group consisting of solvent naphtha light aromatic hydrocarbons and solvent naphtha heavy aromatic hydrocarbons, and more preferably may be solvent naphtha light aromatic hydrocarbons. The solvent naphtha light aromatic hydrocarbons may include C8 to C10 aromatic hydrocarbons, and have a boiling range of 135° C. to 210° C. The solvent naphtha heavy aromatic hydrocarbons may include C9 to C16 aromatic hydrocarbons, and have a boiling range of 165° C. to 290° C.

Any cross-linking agent may be used as the cross-linking agent as long as it can cross-link the Polymeric Methylenediphenyl diisocyanate and the toluene diisocyanate, which are the capsule-forming materials, and may be preferably polyoxypropylenediamine or polyoxypropylenetriamine, and more preferably polyoxypropylenediamine.

The polyoxypropylenediamine may have an average molecular weight of 100 g/mol to 500 g/mol, preferably an average molecular weight of 200 g/mol to 500 g/mol, and more preferably an average molecular weight of 200 g/mol to 300 g/mol.

The polyoxypropylenediamine may have an average degree of polymerization of 1 to 7, preferably an average degree of polymerization of 2 to 7, and more preferably an average degree of polymerization of 2 to 3.

The dispersant may be any one or more selected from the group consisting of naphthalenesulfonic acid and a formaldehyde condensate.

The capsule-forming material and the cross-linking agent may be included in a weight ratio of 1:0.1 to 1:3, preferably 1:0.2 to 1:1, and more preferably, 1:0.3 to 1:0.8.

In one specific embodiment of the present invention, it was confirmed that a pesticide formulation in which a combination of Polymeric Methylenediphenyl diisocyanate (PMDI) and 2,4-toluene diisocyanate is used as the capsule-forming material has superior diffusibility from the inside to outside of a capsule compared to pesticide formulations in which lambda-cyhalothrin of an existing EW formulation and Polymeric Methylenediphenyl diisocyanate (PMDI) are used alone as the capsule-forming material, which results in an insecticidal effect that appears rapidly and lasts for a long time. Also, it was confirmed that a controlled release pesticide including Polymeric Methylenediphenyl diisocyanate and toluene diisocyanate in a certain ratio exhibits the fastest and best insecticidal effect. Further, it was confirmed that a composition including a capsule-forming material and a cross-linking agent in a certain ratio has the best insecticidal effect when solvent naphtha heavy aromatic hydrocarbons is used as a solvent and polyoxypropylenediamine is used as a cross-linking agent.

Therefore, the controlled release pesticide of the present invention may be used effectively used as a novel pesticide formulation because it exhibits a rapid insecticidal effect due to the excellent diffusibility of the insecticidal agent included therein, and also has excellent sustainability of the insecticidal effect.

Hereinafter, the present invention will be described in detail with reference to Examples and Experimental Examples thereof.

However, it should be understood that the following Experimental Examples are provided to specifically illustrate the present invention and are not intended to limit the contents of the present invention.

### Example 1: Preparation of Controlled Release Pesticide

To prepare an oil phase, lambda-cyhalothrin (an insecticidal agent) was dissolved in a solvent light aromatic hydrocarbons at room temperature ranging from 20° C. to 25° C., and Polymeric Methylenediphenyl diisocyanate (PMDI) and 2,4-toluene diisocyanate, which are capsule-forming materials, were added, and further stirred. To prepare a water phase, an emulsifier was mixed in water and stirred. The prepared oil phase and water phase were mixed and stirred at room temperature ranging from 20° C. to 25° C. Polyoxypropylenediamine and polydimethylsiloxane were added as the cross-linking agent and the anti-foaming agent, respectively, to the mixed oil and water phases at room temperature. One hour later, FT-IR measurement was performed to check an —NCO peak. Then, a dispersant, a thickener, an anti-freezing agent, and a preservative were additionally added to prepare a controlled release pesticide.

TABLE 1

| | Materials | % (wt/wt) |
|---|---|---|
| Oil phase | L-CH (lambda-cyhalothrin) (an active | 9.97 |
| | ingredient) | |
| | Solvent naphtha light aromatic | 5.50 |
| | hydrocarbons | |
| | Polymeric Methylenediphenyl | 0.15 |
| | diisocyanate (PMDI, for capsule | |
| | formation) | |
| | 2,4-toluene diisocyanate (TDI, for | 0.55 |
| | capsule formation) | |
| Water phase | Emulsifier | 15.00 |
| | Water | 33.28 |
| Cross-linking agent | Polyoxypropylenediamine | 0.35 |
| Dispersant | Naphthalenesulfonic acid, formaldehyde | 1.00 |
| | condensate | |
| Anti-freezing agent | Propylene glycol | 4.00 |
| Thickener | Xanthan gum | 0.10 |
| Preservative | Bronopol | 0.13 |
| Anti-foaming agent | Polydimethylsiloxane | 0.20 |
| Thickener | Montmorillonite | 0.50 |
| Dispersion medium | Water | 29.07 |
| | Total | 100.0 |

### Comparative Example 1: Preparation of Controlled Release Pesticide

A controlled release pesticide was prepared in the same manner as in Example 1, except that 1.02% by weight of the Polymeric Methylenediphenyl diisocyanate (PMDI) was used alone as the capsule-forming material and solvent naphtha heavy aromatic hydrocarbons was used instead of the solvent naphtha light aromatic hydrocarbon used in the controlled release pesticide prepared in Example 1.

### Experimental Example 1: Confirmation of Diffusibility of Controlled Release Pesticide

The diffusibility of each of the controlled release pesticides prepared in Example 1 and Comparative Example 1 was confirmed as follows.

Specifically, a reverse-phase silica gel TLC plate (Merck, RP-18 F254s) was prepared, and a spot of each sample was taken at a distance of 1 to 2 cm apart from one end of the TLC plate using a microglass tube for TLC and placed at an oblique angle in a TLC chamber containing a developing solvent. A solvent prepared by mixing ethyl acetate and hexane in a volume ratio of 1:19 was used as the developing solvent. Each sample was developed for 10 minutes, and the TLC plate was then taken out and left at room temperature for 30 minutes. To check the diffusibility of lambda-cyhalothrin, 10 mL of ultrapure water was mixed with 20 g of KOH, and then adjusted to 100 mL with methanol to prepare a primary spray solution. The prepared primary spray solution was sprayed on the TLC plate, and left for 10 minutes, and a secondary spray solution was sprayed. The secondary spray solution was prepared by mixing a solution in which 0.4 g of 2-(4-iodophenyl)-3-(4-nitrophenyl)-5-phenyl tetrazolium chloride was mixed with 100 mL of ultrapure water with a solution in which 0.1 g of phenazonium methosulfate was mixed with 100 mL of ultrapure water in a volume ratio of 10:2.

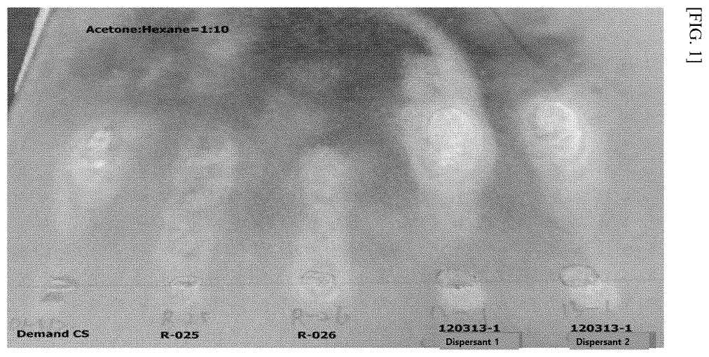

As a result, as shown in FIG. 1, it was confirmed that the pesticide formulations (using dispersant 1 (Cas No. 36290-04-7) and dispersant 2 (Cas No. 68425-94-5)) in which a combination of Polymeric Methylenediphenyl diisocyanate (PMDI) and 2,4-toluene diisocyanate was used as the capsule-forming material had superior diffusibility from the inside to outside of a capsule compared to the lambda-cyhalothrin (Demand CS) of the conventional capsule suspension (CS) formulation and the pesticide formulations (R-025 and R-026) of Comparative Example 1 in which Polymeric Methylenediphenyl diisocyanate (PMDI) was used alone as the capsule-forming material. The above results show that the pesticide formulation in which a combination of Polymeric Methylenediphenyl diisocyanate (PMDI) and 2,4-toluene diisocyanate was used as the capsule-forming material had excellent diffusibility, thereby exhibiting an excellent insecticidal effect.

### Experimental Example 2: Confirmation of Insecticidal Effect of Controlled Release Pesticide According to Ratio of Capsule-Forming Materials

In the controlled release pesticide prepared in Example 1, the ratio of Polymeric Methylenediphenyl diisocyanate (PMDI) and 2,4-toluene diisocyanate, which are the capsule-forming materials, was varied, and pesticide formulations were prepared at each ratio using dispersant 1 (Cas No. 36290-04-7) and dispersant 2 (Cas No. 68425-94-5) as dispersants. Then, the insecticidal effect was confirmed as follows.

Specifically, as shown in Table 2 below, the ratio of Polymeric Methylenediphenyl diisocyanate (PMDI) and 2,4-toluene diisocyanate was varied to prepare six formulations. Then, five cockroaches were treated with a pesticide solution diluted to 0.3%, and then the number of cockroaches that did not move over time were counted.

As a result, as shown in Tables 3 to 6 below, it was confirmed that the controlled release pesticides (samples 1 and 2) including 0.15% by weight of Polymeric Methylenediphenyl diisocyanate (PMDI) and 0.55% by weight of 2,4-toluene diisocyanate had the fastest and best insecticidal effect. Also, samples 3 and 4 had the same PMDI and TDI ratio as samples 1 and 2, but the absolute weight of each capsule-forming material increased twofold. As a result, it was confirmed that the release rate of the pesticide collected in the formed capsule decreased as the thickness of the capsule increased, which resulted in a poor fast-acting property compared to samples 1 and 2.

TABLE 2

| | PMDI | TDI | | Sample |
|---|---|---|---|---|
| Solvent | (% by weight) | (% by weight) | Dispersant | No. |
| Solvent | 0.15 | 0.55 | Dispersant 1 | 1 |
| naphtha light | | | Dispersant 2 | 2 |
| aromatic | 0.225 | 0.82 | Dispersant 1 | 5 |
| hydrocarbons | | | Dispersant 2 | 6 |
| | 0.30 | 1.1 | Dispersant 1 | 3 |
| | | | Dispersant 2 | 4 |

TABLE 3

| Elapsed time | | | | | | | |
|---|---|---|---|---|---|---|---|
| (1^{st} experiment) | | Sample 1 | Sample 2 | Sample 3 | Sample 4 | Sample 5 | Sample 6 |
| Initiation | | 0 | 0 | 0 | 0 | 0 | 0 |
| 30 | minutes | 5 | 5 | 4 | 5 | 5 | 3 |
| 60 | minutes | 5 | 5 | 4 | 5 | 5 | 3 |
| 90 | minutes | 5 | 5 | 4 | 5 | 5 | 3 |
| 2 | hours | 5 | 5 | 5 | 5 | 5 | 4 |
| 3 | hours | 5 | 5 | 5 | 5 | 5 | 4 |
| 4 | hours | 5 | 5 | 5 | 5 | 5 | 5 |

TABLE 4

| Elapsed time | | | | | | | |
|---|---|---|---|---|---|---|---|
| (2^{nd} experiment) | | Sample 1 | Sample 2 | Sample 3 | Sample 4 | Sample 5 | Sample 6 |
| Initiation | | 0 | 0 | 0 | 0 | 0 | 0 |
| 30 | minutes | 4 | 4 | 5 | 3 | 4 | 4 |
| 60 | minutes | 4 | 4 | 5 | 4 | 4 | 4 |
| 90 | minutes | 4 | 5 | 5 | 4 | 5 | 5 |
| 2 | hours | 5 | 5 | 5 | 4 | 5 | 5 |
| 3 | hours | 5 | 5 | 5 | 4 | 5 | 5 |
| 4 | hours | 5 | 5 | 5 | 5 | 5 | 5 |

TABLE 5

| Elapsed time | | | | | | | |
|---|---|---|---|---|---|---|---|
| (3^{rd} experiment) | | Sample 1 | Sample 2 | Sample 3 | Sample 4 | Sample 5 | Sample 6 |
| Initiation | | 0 | 0 | 0 | 0 | 0 | 0 |
| 30 | minutes | 5 | 5 | 4 | 4 | 4 | 5 |
| 60 | minutes | 5 | 5 | 5 | 5 | 4 | 5 |
| 90 | minutes | 5 | 5 | 5 | 5 | 5 | 5 |
| 2 | hours | 5 | 5 | 5 | 5 | 5 | 5 |
| 3 | hours | 5 | 5 | 5 | 5 | 5 | 5 |
| 4 | hours | 5 | 5 | 5 | 5 | 5 | 5 |

TABLE 6

| Elapsed time | | | | | | | |
|---|---|---|---|---|---|---|---|
| (average) | | Sample 1 | Sample 2 | Sample 3 | Sample 4 | Sample 5 | Sample 6 |
| Initiation | | 0 | 0 | 0 | 0 | 0 | 0 |
| 30 | minutes | 4.67 | 4.67 | 4.33 | 4 | 4.33 | 4 |
| 60 | minutes | 4.67 | 4.67 | 4.67 | 4.67 | 4.33 | 4 |
| 90 | minutes | 4.67 | 5 | 4.67 | 4.67 | 5 | 4.33 |
| 2 | hours | 5 | 5 | 5 | 4.67 | 5 | 4.67 |
| 3 | hours | 5 | 5 | 5 | 4.67 | 5 | 4.67 |
| 4 | hours | 5 | 5 | 5 | 5 | 5 | 5 |

### Experimental Example 3: Confirmation of Insecticidal Effect of Controlled Release Pesticide According to Size of Capsule

For pesticide formulations in which the particle size of the capsule was adjusted by varying the mixing ratio of isocyanate materials such as PMDI and 2,4-TDI, which are capsule-forming materials in the oil phase, and polyoxypropylenediamine, which is a cross-linking agent in the water phase, the insecticidal effect was confirmed as follows. When preparing the capsule, the oil phase and the water phase are mixed. In this case, the particle size may be adjusted according to the stirring speed. By increasing the stirring speed, the particle size may be adjusted to be small. After the particle size was checked, the particle size may be maintained by adding a cross-linking agent.

Specifically, the ratio of isocyanate in a composition, which includes 0.15% by weight of Polymeric Methylenediphenyl diisocyanate (PMDI) and 0.55% by weight of 2,4-toluene diisocyanate, and polyoxypropylenediamine was varied to prepare seven formulations with various particle sizes. Then, five cockroaches were treated with a pesticide solution diluted to 0.3%, and the number of dead cockroaches were counted 48 hours later.

As a result, as shown in Table 7 below, it was confirmed that a capsule having a larger particle size exhibited a superior insecticidal effect compared to a capsule having a smaller particle size, and the insecticidal effect increased until the particle size of the capsule reached 11 μm, and decreased when the particle size became greater than 11 μm. The above results show that, when the particle size was too small, it was difficult for the capsule to exhibit the insecticidal effect because the capsule stuck to the body of pests.

TABLE 7

| Average | Isocyanate (% by weight)/ | Number of dead |
|---|---|---|
| particle | cross-linking agent | cockroaches |
| size (μm) | (% by weight) | (mortality rate) |
| 2.6 | 0.7/1.4 | 3.3 (66%) |
| 2.6 | 1.4/2.4 | 3.7 (74%) |
| 8.2 | 0.7/0.7 | 3.3 (66%) |
| 5.5 | 0.7/0.5 | 3.7 (74%) |
| 5.6 | 0.7/0.3 | 3 (60%) |
| 10.8 | 0.7/0.5 | 4 (80%) |
| 11 | 0.7/0.3 | 4.7 (94%) |
| 15 | 0.7/0.3 | 3 (60%) |

### Experimental Example 4: Confirmation of Insecticidal Effect of Controlled Release Pesticide According to Type of Solvent and Cross-Linking Agent

Various types of solvents or cross-linking agents were used to prepare pesticide formulations, and insecticidal effects were confirmed as follows.

Specifically, pesticide formulations were prepared using two types of solvent naphtha heavy aromatic hydrocarbons (heavy aromatic solvent naphtha 1 and 2), which have different boiling temperature ranges, or solvent naphtha light aromatic hydrocarbons as the solvent and using polyoxypropylenediamine 1 having a degree of polymerization of 2.6 and an average molecular weight of 230 g/mol, polyoxypropylenediamine 2 having a degree of polymerization of 6.1 and an average molecular weight of 400 g/mol, or polyoxypropylenetriamine as the cross-linking agent. Then, five cockroaches were treated with a pesticide solution diluted to 0.3%, and the number of dead cockroaches were counted 48 hours later.

As a result, as shown in Table 8 below, it was confirmed that the pesticide formulation, in which solvent naphtha heavy aromatic hydrocarbons and polyoxypropylenediamine 1 were used as the solvent and the cross-linking agent, respectively, had the best insecticidal effect.

TABLE 8

| | | Number of | | |
|---|---|---|---|---|
| | | dead | | |
| | Sample | cockroaches | | |
| | number | (average) | Solvent | Cross-linking agent |
| R-025 | 6 | 4.7 | Heavy | Polyoxypropylenediamine 1 |
| R-019 | 1 | 4 | aromatic | Polyoxypropylenediamine 2 |
| R-024 | 5 | 3.3 | solvent | Polyoxypropylenetriamine |
| | | | naphtha 1 | |
| R-026 | 7 | 4.7 | Heavy | Polyoxypropylenediamine 1 |
| R-020-1 | 2 | 3.3 | aromatic | Polyoxypropylenediamine 2 |
| R-023 | 4 | 4 | solvent | Polyoxypropylenetriamine |
| | | | naphtha 2 | |
| R-027 | 8 | 3 | solvent | Polyoxypropylenediamine 1 |
| R-022 | 3 | 4 | naphtha | Polyoxypropylenetriamine |
| | | | light | |
| | | | aromatic | |
| | | | hydrocar- | |
| | | | bons | |

### Experimental Example 5: Confirmation of Fast-Acting Property of Controlled Release Pesticide

A pest was treated with the controlled release pesticide, and the insecticidal effect after 48 hours (i.e., a fast-acting property) was confirmed as follows.

Lambda-cyhalothrin (Old lambdastar) of the existing EW formulation, the lambda-cyhalothrin (Demand CS) of the existing capsule suspension (CS) formulation, and the controlled release pesticide (New lambdastar) prepared in Example 1 were diluted to 0.15% or 0.6% (lambda-cyhalothrin serving as the insecticidal agent was included at 0.015% or 0.06%, respectively, based on the total weight of the pesticide), and then sprayed on a plywood panel using an air compressed spray. Thereafter, the pesticide-treated panel was placed in a container with a lid. 48 hours later, pests (cockroaches, crickets, flies, and ants) were placed in the corresponding container, and exposed to the pesticide-treated panel for 5 minutes, and the mortality of the pests was then evaluated.

As a result, as shown in Table 9 below, it was confirmed that the controlled release pesticide (New lambdastar) of Example 1 had a higher average mortality (%) in all the pests when the pests were treated with New lambdastar, compared to when the pests were treated with lambda-cyhalothrin (Old lambdastar) of the existing EW formulation, and had a superior insecticidal effect when the pesticide was treated at a concentration of 0.6%, compared to when the drug was treated at a concentration of 0.15%. Also, it was confirmed that the controlled release pesticide (New lambdastar) of Example 1 had an equivalent level of average mortality when the pests were treated with New lambdastar, compared to when the pests were treated with the lambda-cyhalothrin (Demand CS) of the existing capsule suspension (CS) formulation.

The above results show that the controlled release pesticide formulation of the present invention may be used as a novel pesticide formulation because it exhibits an excellent fast-acting property compared to the lambda-cyhalothrin of the existing EW formulation, and exhibits an equivalent level of fast-acting property compared to the existing capsule suspension formulation.

TABLE 9

| | Avg. % Knockdown | | | | | | | Avg. % Mortality | | |
|---|---|---|---|---|---|---|---|---|---|---|
| Treatment | 5 min | 15 min | 30 min | 45 min | 1 hr | 2 hr | 4 hr | 24 hr | 48 hr | 72 hr |
| Argentin Ant - 48 Hour | | | | | | | | | | |
| 0.015% “Old” LambdaStart | 0 | 0 | 0 | 0.6 | 0.6 | 0 | 0.6 | 1.2 | 6.6 | 16.8 |
| 0.06% “Old” LambdaStart | 0 | 0 | 17.3 | 58.0 | 65.4 | 25.3 | 37.7 | 8.0 | 15.4 | 24.7 |
| 0.015% “New” LambdaStart | 0 | 11.7 | 79.1 | 93.9 | 84.7 | 73.0 | 81.6 | 60.1 | 62.0 | 65.6 |
| 0.06% “New” LambdaStart | 5.4 | 83.9 | 98.0 | 100 | 100 | 100 | 100 | 92.6 | 94.0 | 96.0 |
| 0.015% Demand CS | 0 | 0 | 25.3 | 69.5 | 72.7 | 41.6 | 49.4 | 26.6 | 46.1 | 55.8 |
| 0.06% Demand CS | 3.2 | 88.0 | 100 | 100 | 100 | 95.6 | 96.2 | 81.0 | 90.5 | 97.5 |
| Untreated Control | 0 | 0 | 0 | 0 | 0 | 0 | 0 | 1.8 | 4.2 | 9.5 |
| House Cricket - 48 Hour | | | | | | | | | | |
| 0.015% “Old” LambdaStart | 0 | 0 | 0 | 0 | 2.0 | 2.0 | 2.0 | 0 | 0 | 0 |
| 0.06% “Old” LambdaStart | 0 | 0 | 0 | 2.0 | 34.7 | 38.8 | 40.8 | 0 | 0 | 0 |
| 0.015% “New” LambdaStart | 0 | 0 | 10.2 | 81.6 | 89.8 | 100 | 100 | 38.8 | 57.1 | 73.5 |
| 0.06% “New” LambdaStart | 0 | 74.5 | 100 | 100 | 100 | 100 | 100 | 62.7 | 86.3 | 100 |
| 0.015% Demand CS | 0 | 4.0 | 48.0 | 78.0 | 94.0 | 100 | 100 | 50.0 | 78.0 | 92.0 |
| 0.06% Demand CS | 0 | 24.0 | 80.0 | 100 | 100 | 100 | 100 | 82.0 | 96.0 | 100 |
| Untreated Control | 0 | 0 | 0 | 0 | 0 | 0 | 0 | 0 | 0 | 0 |
| House Fly - 48 Hour | | | | | | | | | | |
| 0.015% “Old” LambdaStart | 0 | 6.1 | 6.1 | 6.1 | 8.2 | 10.2 | 16.3 | 10.2 | 24.5 | 42.9 |
| 0.06% “Old” LambdaStart | 0 | 0 | 8.0 | 10.0 | 10.0 | 10.0 | 8.0 | 6.0 | 12.0 | 32.0 |
| 0.015% “New” LambdaStart | 0 | 66.0 | 100 | 100 | 100 | 92.0 | 80.0 | 48.0 | 48.0 | 76.0 |
| 0.06% “New” LambdaStart | 0 | 100 | 100 | 100 | 100 | 100 | 100 | 64.0 | 80.0 | 98.0 |
| 0.015% Demand CS | 0 | 50.0 | 90.0 | 96.0 | 92.0 | 92.0 | 84.0 | 40.0 | 54.0 | 74.0 |
| 0.06% Demand CS | 0 | 98.0 | 100 | 100 | 100 | 100 | 98.0 | 44.0 | 64.0 | 86.0 |
| Untreated Control | 0 | 0 | 0 | 0 | 0 | 0 | 0 | 0 | 0 | 4.0 |
| German Cockroach - 48 Hour | | | | | | | | | | |
| 0.015% “Old” LambdaStart | 2.0 | 0 | 0 | 0 | 0 | 0 | 0 | 0 | 0 | 0 |
| 0.06% “Old” LambdaStart | 0 | 0 | 2.0 | 0 | 0 | 10.0 | 14.0 | 4.0 | 12.0 | 24.0 |
| 0.015% “New” LambdaStart | 0 | 14.0 | 56.0 | 80.0 | 98.0 | 100 | 100 | 50.0 | 62.0 | 84.0 |
| 0.06% “New” LambdaStart | 10.2 | 63.3 | 91.8 | 100 | 100 | 100 | 100 | 46.9 | 65.3 | 77.6 |
| 0.015% Demand CS | 0 | 4.0 | 24.0 | 54.0 | 66.0 | 100 | 100 | 58.0 | 76.0 | 86.0 |
| 0.06% Demand CS | 2 | 14.3 | 75.5 | 91.8 | 98.0 | 100 | 100 | 75.5 | 81.6 | 81.6 |
| Untreated Control | 0 | 0 | 0 | 0 | 0 | 0 | 0 | 0 | 0 | 0 |

### Experimental Example 6: Confirmation of Sustainability of Controlled Release Pesticide

A pest was treated with the controlled release pesticide, and the insecticidal effect after 12 weeks (i.e., sustainability) was confirmed as follows.

Lambda-cyhalothrin (Old lambdastar) of the existing EW formulation, the lambda-cyhalothrin (Demand CS) of the existing capsule suspension (CS) formulation, and the controlled release pesticide (New lambdastar) prepared in Example 1 were diluted to 0.15% or 0.6% (lambda-cyhalothrin serving as the insecticidal agent was included at 0.015% or 0.06%, respectively, based on the total weight of the pesticide), and then sprayed on a plywood panel using an air compressed spray. Thereafter, the pesticide-treated panel was placed in a container with a lid. After the elapsed time of 12 weeks, pests (cockroaches, crickets, flies, and ants) were placed in the corresponding container, and exposed to the drug-treated panel for 5 minutes, and the mortality of the pests was then observed and evaluated for 72 hours.

As a result, as shown in Table 10 below, it was confirmed that the controlled release pesticide (New lambdastar) of Example 1 had a higher average mortality (%) in all the pests when the pests were treated with New lambdastar, compared to when the pests were treated with lambda-cyhalothrin (Old lambdastar) of the existing EW formulation, and had a superior insecticidal effect when the drug was treated at a concentration of 0.6%, compared to when the pesticide was treated at a concentration of 0.15%. Also, it was confirmed that when the pests were treated with New lambdastar, the controlled release pesticide (New lambdastar) of Example 1 had the average mortality of more than equivalent, compared to when the pests were treated with the lambda-cyhalothrin (Demand CS) of the existing capsule suspension (CS) formulation.

The above results show that the controlled release pesticide formulation of the present invention may be used as a novel pesticide formulation having excellent sustainability because it exhibits superior sustainability compared to the lambda-cyhalothrin of the existing EW formulation and the capsule suspension formulation.

TABLE 10

| | Avg. % Knockdown | | | | | | | % Moribund | | | % Mortality | | |
|---|---|---|---|---|---|---|---|---|---|---|---|---|---|
| Treatment | 5 min | 15 min | 30 min | 45 min | 1 hr | 2 hr | 4 hr | 24 hr | | 48 hr | | 72 hr | |
| Argentin Ant - 12 Weeks | | | | | | | | | | | | | |
| 0.015% “Old” LambdaStart | 0 | 0 | 2.9 | 2.9 | 2.9 | 2.9 | 4.4 | 0.7 | 11.0 | 8.8 | 29.4 | 7.4 | 48.5 |
| 0.06% “Old” LambdaStart | 0 | 1.4 | 2.9 | 3.6 | 3.6 | 2.9 | 2.9 | 7.9 | 7.2 | 10.1 | 56.1 | 0.7 | 74.8 |
| 0.015% “New” LambdaStart | 0 | 19.4 | 64.2 | 70.1 | 76.9 | 77.6 | 74.6 | 6.7 | 92.5 | 0 | 100 | 0 | 100 |
| 0.06% “New” LambdaStart | 0 | 82.0 | 98.6 | 98.6 | 100 | 100 | 94.2 | 5.8 | 94.2 | 0 | 100 | 0 | 100 |
| 0.015% Demand CS | 0 | 0 | 3.8 | 8.3 | 20.5 | 21.2 | 15.2 | 28.0 | 23.5 | 2.3 | 87.9 | 0 | 97.0 |
| 0.06% Demand CS | 0 | 79.2 | 91.9 | 94.6 | 94.6 | 95.3 | 85.9 | 9.4 | 90.6 | 0 | 100 | 0 | 100 |
| Untreated Control | 0 | 0 | 0 | 0 | 0 | 0 | 0 | 1.6 | 2.3 | 8.6 | 14.8 | 3.1 | 25.8 |
| House Cricket - 12 Weeks | | | | | | | | | | | | | |
| 0.015% “Old” LambdaStart | 0 | 0 | 0 | 0 | 0 | 0 | 0 | 0 | 2.0 | 0 | 2.0 | 0 | 2.0 |
| 0.06% “Old” LambdaStart | 0 | 0 | 0 | 0 | 0 | 0 | 0 | 0 | 0 | 0 | 0 | 0 | 0 |
| 0.015% “New” LambdaStart | 0 | 2.0 | 56.0 | 84.0 | 92.0 | 96.0 | 100 | 74.0 | 22.0 | 28.0 | 68.0 | 2.0 | 90.0 |
| 0.06% “New” LambdaStart | 0 | 76.0 | 98.0 | 100 | 100 | 100 | 100 | 70.0 | 30.0 | 12.0 | 88.0 | 0 | 100 |
| 0.015% Demand CS | 0 | 0 | 10.0 | 20.0 | 44.0 | 46.0 | 96.0 | 66.0 | 16.0 | 28.0 | 56.0 | 6.0 | 76.0 |
| 0.06% Demand CS | 0 | 14.0 | 54.0 | 100 | 100 | 100 | 100 | 66.0 | 34.0 | 16.0 | 84.0 | 2.0 | 98.0 |
| Untreated Control | 0 | 0 | 0 | 0 | 0 | 0 | 0 | 0 | 0 | 0 | 0 | 0 | 0 |
| House Fly - 12 Weeks | | | | | | | | | | | | | |
| 0.015% “Old” LambdaStart | 0 | 2.0 | 2.0 | 2.0 | 2.0 | 2.0 | 2.0 | 2.0 | 0 | 0 | 2.0 | 0 | 8.0 |
| 0.06% “Old” LambdaStart | 0 | 0 | 0 | 0 | 0 | 0 | 0 | 0 | 2.1 | 4.2 | 16.7 | 0 | 25.0 |
| 0.015% “New” LambdaStart | 12.0 | 50.0 | 88.0 | 98.0 | 94.0 | 90.0 | 90.0 | 32.0 | 54.0 | 32.0 | 56.0 | 8.0 | 82.0 |
| 0.06% “New” LambdaStart | 44.9 | 98.0 | 100 | 100 | 100 | 100 | 100 | 34.7 | 63.3 | 16.3 | 81.6 | 4.1 | 95.9 |
| 0.015% Demand CS | 2.0 | 20.0 | 54.0 | 68.0 | 78.0 | 62.0 | 56.0 | 10.0 | 46.0 | 14.0 | 52.0 | 2.0 | 62.0 |
| 0.06% Demand CS | 8.0 | 96.0 | 100 | 100 | 100 | 100 | 100 | 42.0 | 52.0 | 18.0 | 82.0 | 12.0 | 88.0 |
| Untreated Control | 0 | 0 | 0 | 0 | 0 | 0 | 0 | 0 | 2.0 | 0 | 2.0 | 0 | 2.0 |
| German Cockroach - 12 Weeks | | | | | | | | | | | | | |
| 0.015% “Old” LambdaStart | 0 | 0 | 0 | 0 | 0 | 0 | 0 | 2.0 | 0 | 0 | 2.0 | 0 | 2.0 |
| 0.06% “Old” LambdaStart | 0 | 0 | 0 | 0 | 0 | 0 | 0 | 0 | 0 | 0 | 0 | 0 | 0 |
| 0.015% “New” LambdaStart | 0 | 0 | 2.0 | 30.6 | 49.0 | 67.3 | 83.7 | 69.4 | 10.2 | 51.0 | 32.7 | 14.3 | 69.4 |
| 0.06% “New” LambdaStart | 0 | 0 | 40.0 | 60.0 | 98.0 | 100 | 100 | 96.0 | 4.0 | 84.0 | 16.0 | 44.0 | 56.0 |
| 0.015% Demand CS | 0 | 0 | 0 | 14.0 | 12.0 | 26.0 | 46.0 | 44.0 | 0 | 48.0 | 4.0 | 14.0 | 38.0 |
| 0.06% Demand CS | 0 | 0 | 20.0 | 40.0 | 66.0 | 76.0 | 90.0 | 86.0 | 8.0 | 72.0 | 24.0 | 48.0 | 48.0 |
| Untreated Control | 0 | 0 | 0 | 0 | 0 | 0 | 0 | 0 | 0 | 0 | 0 | 0 | 0 |

1. A microcapsule for a controlled release pesticide, wherein the microcapsule is prepared from Polymeric Methylenediphenyl diisocyanate (PMDI) and toluene diisocyanate (TDI).

2. The microcapsule of claim 1, wherein the microcapsule is prepared from a composition comprising 0.1% by weight to 0.5% by weight of the Polymeric Methylenediphenyl diisocyanate and 0.3% by weight to 1.5% by weight of the toluene diisocyanate.

3. The microcapsule of claim 1, wherein the microcapsule is prepared from a composition comprising 0.1% by weight to 0.2% by weight of the Polymeric Methylenediphenyl diisocyanate and 0.3% by weight to 0.7% by weight of the toluene diisocyanate.

4. The microcapsule of claim 1, wherein the microcapsule has a particle size of 1 μm to 20 μm.

5. A controlled release pesticide comprising the microcapsule of claim 1; and a pesticidal agent included in a space surrounded by the microcapsule.

6. The controlled release pesticide of claim 5, wherein the pesticidal agent is lambda-cyhalothrin.

7. A composition for preparing a controlled release pesticide comprising a pesticidal agent; a solvent; Polymeric Methylenediphenyl diisocyanate (PMDI) and toluene diisocyanate (TDI) serving as capsule-forming materials; a cross-linking agent; and a dispersant.

8. The composition of claim 7, wherein the composition comprises 0.1% by weight to 0.5% by weight of the Polymeric Methylenediphenyl diisocyanate and 0.3% by weight to 1.5% by weight of the toluene diisocyanate.

9. The composition of claim 7, wherein the composition comprises 0.1% by weight to 0.2% by weight of the Polymeric Methylenediphenyl diisocyanate and 0.3% by weight to 0.7% by weight of the toluene diisocyanate.

10. The composition of claim 7, wherein the solvent is any one or more selected from the group consisting of solvent naphtha light aromatic hydrocarbons and solvent naphtha heavy aromatic hydrocarbons.

11. The composition of claim 7, wherein the cross-linking agent is polyoxypropylenediamine or polyoxypropylenetriamine.

12. The composition of claim 11, wherein the polyoxypropylenediamine has an average molecular weight of 100 g/mol to 500 g/mol.

13. The composition of claim 11, wherein the polyoxypropylenediamine has an average degree of polymerization of 1 to 7.

14. The composition of claim 7, wherein the dispersant is any one or more selected from the group consisting of naphthalenesulfonic acid and a formaldehyde condensate.

15. The composition of claim 7, wherein the capsule-forming materials and the cross-linking agent are included in a weight ratio of 1:0.1 to 1:3.
